(19) United States
(12) Patent Application Publication
(10) Pub. No.: US 2002/0062208 A1
(43) Pub. Date: May 23, 2002

(54) Method and apparatus for visualization of microprocessor pipeline operation

(76) Inventors: Christopher A. Gomez, Campbell, CA (US); Wayne I. Yamamoto, Saratoga, CA (US)

Correspondence Address: ROSENTHAL & OSHA L.L.P., Suite 4550, 700 Louisiana, Houston, TX, 77002, US

(21) Appl. No.: 09/993,074

(22) Filed: Nov. 19, 2001

Related U.S. Application Data
(60) Provisional application No. 60/252,308, filed on Nov. 21, 2000.

(51) Int. Cl. G06T 11/20; G06F 9/44; G06F 13/10

(52) U.S. Cl. 703/21; 345/440

(57) ABSTRACT

A method and apparatus of visualizing events within a microprocessor include simulating the operation of a microprocessor for a set of instructions, generating the internal state information from the simulation and graphically displaying an execution behavior based on the internal state information. The graphical display represents a flow of the instructions through an internal pipeline in the microprocessor. Execution behavior is selectively displayed based on type of behavior and clock cycle the execution occurred during on the microprocessor. A log of the execution behavior of the set of instructions on the microprocessor is created. The set of instructions is created from a graphical display of selectable instructions.

### CROSS-REFERENCE TO RELATED APPLICATIONS

This application claims benefit of U.S. Provisional Application No. 60/252,308, entitled “Method and Apparatus for Visualization of Microprocessor Pipeline Operation,” filed Nov. 21, 2000.

### BACKGROUND OF INVENTION

In pursuit of the advancement of microprocessor technology, performance characteristics of proposed microprocessor designs are analyzed. Generally, performance characteristics are obtained through the use of computer software that simulates the operation of the proposed design. Most of these simulators are text based and have to display many lines of text to represent the many events occurring in the simulated microprocessor. Further, these simulators must label the multitude of text lines with not only a description of the event occurring, but also, a time period designation representing clock cycles of the microprocessor.

This is because, in most instances, microprocessors execute several instructions on each clock cycle. The execution of multiple instructions concurrently is termed “pipelining”.

Essentially, pipelining is a technique in which a microprocessor begins executing a second instruction before the first has been completed. In other words, several instructions are in the pipeline simultaneously. A pipeline is divided into stages and each stage can execute operations concurrently with the other stages. When a stage completes an operation, the result is passed to the next stage in the pipeline and a next operation is fetched from the preceding stage. The final results of each instruction emerge at the end of the pipeline in rapid succession.

Without a pipeline, a computer processor gets the first instruction from memory, performs the operation it calls for, and then goes to get the next instruction from memory, and so forth. While fetching the instruction, the arithmetic part of the processor is idle. The arithmetic part of the processor must wait until the next instruction is retrieved . With pipelining, the next instructions are fetched while the microprocessor is performing arithmetic operations. Fetched instructions are then held in a buffer until each instruction operation is performed. A microprocessor can increase in the number of instructions that can be performed during a given time period by continuously fetching, buffering, and executing instructions. Further, as long as some operations proceed concurrently, i.e., even if sequential dependency exists among the instructions, the overall processor performance is still improved.

Once the performance characteristics for a proposed design are simulated, the design can be optimized by selectively modifying the original design in view of the performance characteristics. This process requires that the data produced by design simulators be analyzed to determine the resource utilization and corresponding instruction flow.

### SUMMARY OF INVENTION

In general, in one aspect, the present invention is a method of visualizing events within a microprocessor including receiving internal state information representative of events occurring in the microprocessor, and graphically displaying an execution behavior of the instructions on the microprocessor based on the internal state information.

In accordance with one or more embodiments, the method may include receiving a set of instructions, executing the set of instructions on the microprocessor, and receiving the internal state information representative of events occurring in the microprocessor. The method may include receiving a design for the microprocessor, receiving a set of instructions, simulating operation of the microprocessor for the set of instructions from the design, and generating the internal state information representative of events occurring in the microprocessor from the simulation. The method may include receiving a set of instructions, exporting the set of instructions to a microprocessor simulator that simulates operation of the microprocessor for the set of instructions and generates internal state information representative of events occurring within the microprocessor, and receiving the internal state information representative of events occurring in the microprocessor from the microprocessor simulator. The method may include selectively displaying only at least one type of execution behavior of the set of instructions on the microprocessor. The method may include selectively displaying only the execution behavior of the set of instructions on the microprocessor occurring during at least one time period. The method may include creating a log of the execution behavior of the set of instructions on the microprocessor. The method may include graphically displaying selectable instructions, creating a set of instructions from selected instructions, simulating operation of the set of instructions on the microprocessor, generating the internal state information representative of events occurring in the microprocessor from the simulation. The method may include converting the received internal state information representative of events occurring in the microprocessor into a form usable by a display module that graphically displays execution behavior based on internal state information, sending the converted internal state information to the display module for graphical display of the execution behavior based on the converted internal state information. The graphical display may represent a flow of the instructions through an internal pipeline in the microprocessor.

In general, in one aspect, the present invention is a system for visualizing events within a microprocessor. The system includes a program stored on computer-readable media for receiving internal state information representative of events occurring in the microprocessor, and graphically displaying an execution behavior of the set of instructions on the microprocessor based on the internal state information.

In accordance with one or more embodiments, the system may include may include a program stored on computer-readable media for receiving a set of instructions, executing the set of instructions on the microprocessor, and receiving the internal state information representative of events occurring in the microprocessor. The system may include a program stored on computer-readable media for receiving a design for the microprocessor, receiving a set of instructions, simulating operation of the microprocessor for the set of instructions from the design, generating the internal state information representative of events occurring in the microprocessor from the simulation.

In general, in one aspect, the present invention is a system for visualizing events within a microprocessor. The system includes an interface module that receives a set of instructions, a microprocessor simulator that simulates operation of the microprocessor for the set of instructions and generates internal state information representative of events occurring within the microprocessor, and a display module that graphically displays an execution behavior of the set of instructions on the microprocessor based on internal state information. The interface module exports the received set of instructions to the microprocessor simulator, imports the internal state information representative of events occurring in the microprocessor from the microprocessor simulator, and communicates the internal state information to the display module.

In accordance with one or more embodiments, the display module may selectively display only at least one type of execution behavior of the set of instructions on the microprocessor. The display module may selectively display only the execution behavior of the set of instructions on the microprocessor occurring during at least one time period. The interface module may include a conversion module that converts the set of instructions received into a form understandable by the microprocessor simulator and converts the internal state information into a form understandable by the display module.

In general, in one aspect, the present invention is a tool for visualizing events within a microprocessor including means receiving internal state information representative of events occurring in the microprocessor, and means for graphically displaying an execution behavior of the instructions on the microprocessor based on the internal state information.

In accordance with one or more embodiments, the tool may include means for simulating operation of a microprocessor for a set of instructions, and means for generating internal state information from the simulation. The tool may include means for exporting a set of instructions to a simulator in a understandable form, means for importing results from the simulator, and means for converting the results into internal state information representative of events occurring in the microprocessor.

The present invention is user-friendly and provides a visual representation of microprocessor events. The visual representation allows errors and trends to be easily detected and analyzed. Specific cycles and/or instructions may be selectively highlighted. Details markers describing certain events may be selectively displayed. Zoom controls on the visualization allow efficient access to custom-size views. Other advantages and features will become apparent from the following description, including the figures and the claims.

Other aspects and advantages of the invention will be apparent from the following description and the appended claims.

### BRIEF DESCRIPTION OF DRAWINGS

FIG. 1 is a block diagram representing an embodiment of the present invention.

FIG. 2 is a screen shot showing an embodiment of the present invention.

FIG. 3 is a flow diagram showing the operation of an embodiment of the present invention.

FIG. 4 is a flow diagram showing the operation of an embodiment of the present invention.

FIG. 5 is a flow diagram showing the operation of an embodiment of the present invention.

### DETAILED DESCRIPTION

The present invention is a user-friendly tool that aids in the analysis of microprocessor performance characteristics The present invention addresses the visualization of microprocessor internal resource utilization and correlation to instruction flow for the purpose of performance analysis and functional verification.

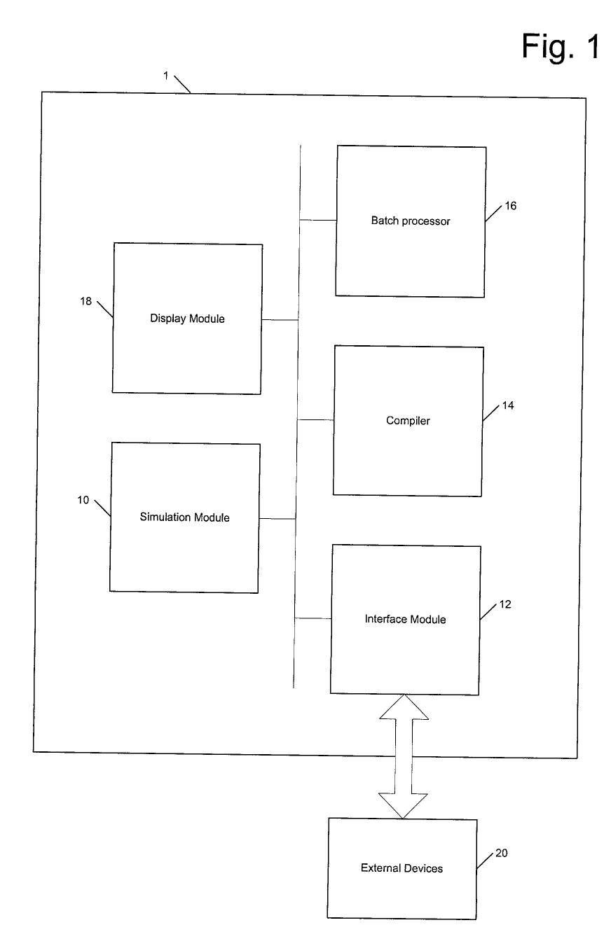

Referring to the drawings wherein like reference characters are used for like parts throughout the several views, FIG. 1 is a block diagram of a system in accordance with one or more embodiments of the present invention. The system may include several modules for performing various, differing functions. Further, the system modules may use internal state information from a separate microprocessor simulator, or may simulate internal state information, to display the execution behavior of the instructions. For example, the system (1) includes a simulation module (10), an input/output interface (12), a compiler (14), a batch processor (16), and a display module (18).

The simulation module (10) performs simulation of a proposed microprocessor design. The simulation module (10) may be a separate external microprocessor simulator. Input/output interface (12) is configured to receive data from and provide data to external devices (20), e.g., an external simulator. Thus, if a separate external simulator is used, the input/output interface (12) is configured to output user instructions to the external simulator in the external simulator's command language. Further, the input/output interface (12) is configured to receive and process the external simulator's results. The ability to interface with an external simulator allows the system to be in conjunction with existing microprocessor simulation technology.

Compiler (14) handles the compiling of binaries and batch processor (16) handles the reception and processing of batch submissions. By integrating the compiling of binaries and batch processing, the system enhances the architectural analysis and debugging of microprocessor designs.

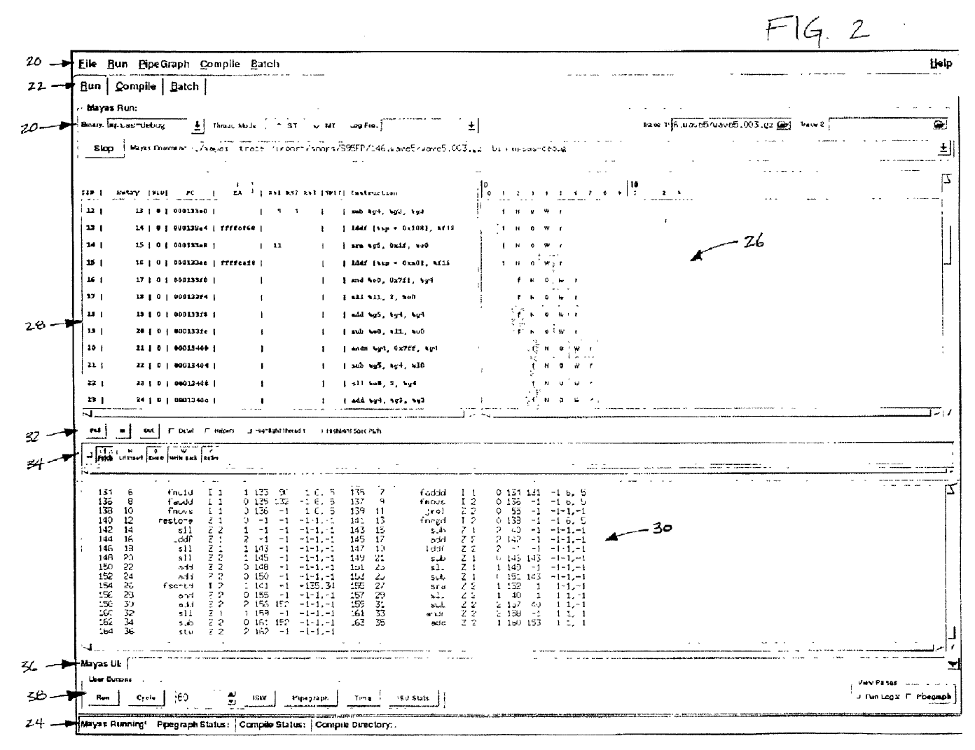

Graphical execution module (18) displays simulation results, system options, user defined characteristics, etc. The graphical execution module (18) may produce a graphical user interface containing various field elements and user interface elements. The field elements contain graphical representations of various data produced and/or received by the system. The user interface elements allow users to input instructions to the system. These field elements and user interface elements of the system (1) are discussed in more detail below with reference to FIG. 2.

Referring to FIG. 2, in one or more embodiments, the present invention may create and arrange various elements on a graphical user interface (GUI). Each of these elements are created by the display module (18) and each may be associated with one or more of the other components discussed above. The display module (18) creates and manages the global menu bars (20), global tab notebook frame (22), and global status bars (24). The pipegraph (26), instruction list (28), log (30) are associated with the simulation module. These elements (26), (28), (30) show information provided by the simulation module. The zoom bar (32), pipestage legend (34), user command line (36), and user buttons (38) are primarily managed by the interface module. Upon user input elements (32), (34), (36), (38) cause the interface module to initiate a function of the system. The zoom bar (32) can be used view the information at a customized size. The pipestage legend identifies the terms used in the pipegraph (26) and allows a user to toggle viewing of certain events in the pipegraph. User command line (36) can be used to input instructions into the system. Likewise, user buttons (38) allow variables to be altered and other usual commands to be issued to the system.

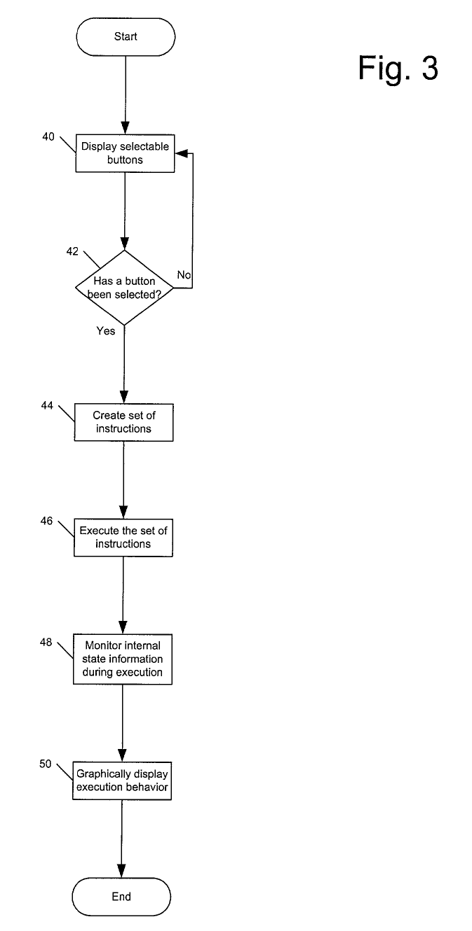

Referring to FIG. 3, a flow diagram representing the operation of an embodiment of the invention is shown. In one aspect, the system of the present invention displays a set of selectable buttons (step 40). This may include displaying a list of potential instructions for user selection, displaying a command line for user input, etc. Further, the system may allow a user to open or import a set of pre-written instructions. In any case, the system displays the selectable buttons and monitors their status.

When a user selects a button or enters a command (step 42), the system creates a corresponding set of microprocessor instructions (step 44). These instructions make up the steps that the microprocessor undertakes in order to carry out the command. Alternatively, as mentioned above, the user may open a prewritten set of instructions and skip step 44. Next, the system executes the set of instructions (step 46) and monitors internal state information of the microprocessor during the execution (step 48). The system uses the internal state information of the microprocessor to determine an execution behavior for the set of instructions. The execution behavior for the set of instructions is graphically displayed (step 50), for example, in pipegraph (26).

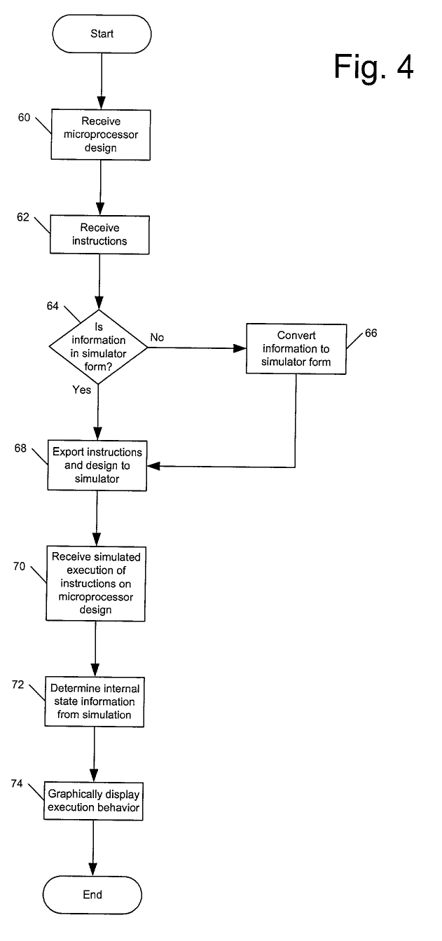

Referring to FIG. 4, in one embodiment, the present invention may use an external microprocessor simulator to obtain the internal state information required to display an execution behavior of a set of instructions. In such a situation, the system receives a microprocessor design (step 60) and instructions (step 62). Alternatively, the external simulator may have a microprocessor design preloaded. Also, as discussed above, the instructions may be input by the user in a variety of ways.

Once the information is received, the system determines if the format of the information is compatible with that required by the simulator (step 64). The system can receive commands in many different forms. At times, these commands may need to be formatted to the language understood by the simulator. If so, the system converts the information into simulator understandable form (step 66). This process also allows the system to be used in conjunction with existing technology. Thus, the microprocessor design, if applicable, and instructions are exported to the external simulator in the standard interface language for the external simulator (step 68).

Because the system uses the same input mechanics as a direct user, the external simulator is actually unaware that the system is present. The external simulator simply executes the set of instructions on the proposed design and returns the results of the simulation. When the system receives the results of the simulation (step 70), the internal state information of the microprocessor design is determined (step 72). The system then uses the internal state information to graphically display an execution behavior for the instructions (step 74).

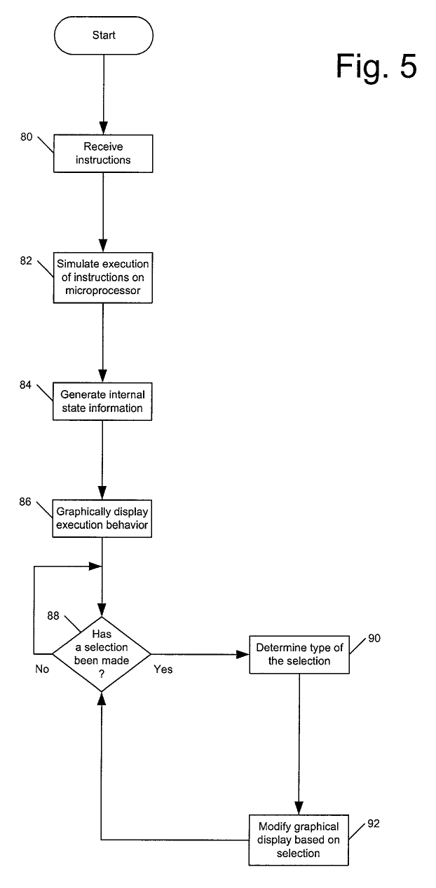

Referring to FIG. 5, in one embodiment, once the system graphically displays the execution behavior of a set of instructions, a user is given the ability to selectively view the data, e.g., highlight by time and instruction, zoom in and out, etc. The system receives instructions (step 80). The system then simulates the execution of the instructions on a microprocessor (step 82) and generates internal state information representing the operation of the microprocessor (step 84). The system uses the internal state information to graphically display an execution behavior of the instructions (step 86).

Once the execution behavior is displayed (step 86), the system monitors whether a selection has been made by a user (step 88). When the user makes a selection, the system determines the type of the selection (step 90). This determination is usually made by the interface module in response to a user command entered in the user command line or selection of a user button. Also, the selection may be a zoom or event toggle selected from the zoom bar or pipestage legend respectively. The system then modifies the graphical display of the execution behavior accordingly (step 92). The user selective view are particularly useful when analyzing large sets of instructions.

In one or more embodiments, the invention can be embodied in computer software tool for visualizing the flow of instructions in the internal pipeline of microprocessor. The software tool may be written, for example, in Tool Command Language (TCL) and C++ languages. The system may be implemented using incrTCL (object oriented TCL), expect (process spawning with raw TTY interaction), and BLT (process management). Further, the system may be implemented with window objects (“widgets”—predefined configurable GUI objects such as frames, listboxes, entries, menu bars, etc.) from, for example, Tool Kit (TK) widget libraries. TK widget libraries are an extension of the TCL language and are collections of widgets or megawidgets (groups of widgets treated as one) such as TIX megawidgets (combo box, tab notebook frame, etc.), incrwidgets (canvas print, etc.), and Bwidgets (color select dialog, font select dialog, etc.).

As discussed above, the system may be used in conjunction with an external microprocessor simulator, for example, the Mayas Performance Simulator (MPS). In such a situation, the system could use the exp_send( ) function to send tty input to MPS. Further, the system could use the expect_background( ) function to receive tty output from MPS. The expect_background( ) function takes a string (or regular expression) sequence and a callback function. When the string (or regular expression) is matched in the tty output buffer the callback is executed. The expect_background( ) function runs in the background and “wakes up” when the tty output buffer is updated. By using this type of interface MPS need not be modified and the display module can interact directly with MPS 10 streams.

Once the tty output is received from MPS, the system sends the tty output to either the Run log (a text widget in the Run Page of the tab notebook) or the display module to be parsed and displayed graphically. When the expect_background( ) function identifies the “Start Pipegraph” string the output lines are sent to the display module until a “Done Pipegraph” string is read. The display module may be derived from the PipeGraph base class which provides a generic waterfall pipegraph. Likewise, methods for drawing pipestages on the pipegraph, inserting instruction info into the instruction list, zooming, drawing a grid, drawing a cycle ruler, etc. are provided by the generic PipeGraph class. The display module thereby inherits all of the functionality of the generic PipeGraph class. The display module also provides UI elements specific to MPS and acts as a Pipestate parser.

Advantages of the present invention may include one or more of the following. In one or more embodiments, the present invention is a user-friendly tool that aids in the analysis of microprocessor performance characteristics. The present invention provides a visual representation of microprocessor events. This visual representation allows errors and trends to be easily detected and analyzed. Specific cycles and/or instructions may be selectively highlighted. Certain events may be selectively toggled on and off in the display. Zoom controls on the visualization allow efficient access to custom-size views. Those skilled in the art will appreciate that the present invention also may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1] A method of visualizing events within a microprocessor comprising:
receiving internal state information representative of events occurring in the microprocessor; and
graphically displaying an execution behavior of the instructions on the microprocessor based on the internal state information.

2] The method of visualizing events within a microprocessor of claim 1, further comprising:
receiving a set of instructions;
executing the set of instructions on the microprocessor; and
monitoring the internal state information representative of events occurring in the microprocessor.

3] The method of visualizing events within a microprocessor of claim 1, further comprising:
receiving a design for the microprocessor;
receiving a set of instructions;
simulating operation of the microprocessor for the set of instructions in accordance with the design; and
generating the internal state information representative of events occurring in the microprocessor from the simulation.

4] The method of visualizing events within a microprocessor of claim 1, further comprising:
receiving a set of instructions;
exporting the set of instructions to a microprocessor simulator that simulates operation of the microprocessor for the set of instructions and generates internal state information representative of events occurring within the microprocessor; and
receiving the internal state information representative of events occurring in the microprocessor from the microprocessor simulator.

5] The method of visualizing events within a microprocessor of claim 3, further comprising:
displaying a selected number of types of execution behavior of the set of instructions on the microprocessor.

6] The method of visualizing events within a microprocessor of claim 3, further comprising:
displaying the execution behavior of the set of instructions on the microprocessor occurring during a selected number of time periods.

7] The method of visualizing events within a microprocessor of claim 3, further comprising:
creating a log of the execution behavior of the set of instructions on the microprocessor.

8] The method of visualizing events within a microprocessor of claim 1, further comprising:
graphically displaying selectable instructions;
creating a set of instructions from selected instructions;
simulating operation of the set of instructions on the microprocessor; and
generating the internal state information representative of events occurring in the microprocessor from the simulation.

9] The method of visualizing events within a microprocessor of claim 4 further comprising:
converting the received internal state information representative of events occurring in the microprocessor into a form usable by a display module that graphically displays execution behavior based on internal state information; and
sending the converted internal state information to the display module for graphical display of the execution behavior based on the converted internal state information.

10] The method of visualizing events within a microprocessor of claim 2, wherein the graphical display rep resents a flow of the instruction s through an internal pipeline in the microprocessor.

11] A software tool for visualizing events within a microprocessor, the software tool comprising:
a program stored on computer-readable media for receiving internal state information representative of events occurring in the microprocessor; and
graphically displaying an execution behavior of the set of instructions on the microprocessor based on the internal state information.

12] The software tool of visualizing events within a microprocessor of claim 11, further comprising:
a program stored on computer-readable media for receiving a set of instructions;
executing the set of instructions on the microprocessor; and
monitoring the internal state information representative of events occurring in the microprocessor.

13] The software tool for visualizing events within a microprocessor of claim 11, further comprising:
a program stored on computer-readable media for receiving a design for the microprocessor;
receiving a set of instructions;
simulating operation of the microprocessor for the set of instructions from the design; and
generating the internal state information representative of events occurring in the microprocessor from the simulation.

14] A system for visualizing events within a microprocessor, the system comprising:
an interface module that receives a set of instructions;
a microprocessor simulator that simulates operation of the microprocessor for the set of instructions and generates internal state information representative of events occurring within the microprocessor; and
a display module that graphically displays an execution behavior of the set of instructions on the microprocessor based on internal state information;
wherein the interface module exports the received set of instructions to the microprocessor simulator, imports the internal state information representative of events occurring in the microprocessor from the microprocessor simulator, and communicates the internal state information to the display module.

15] The system for visualizing events within a microprocessor of claim 14, wherein the display module displays a selected number of types of execution behavior of the set of instructions on the microprocessor.

16] The system for visualizing events within a microprocessor of claim 14, wherein the display module displays the execution behavior of the set of instructions on the microprocessor occurring during a selected number of time periods.

17] The system for visualizing events within a microprocessor of claim 14, the interface module comprising:
a conversion module that converts the set of instructions received into a form understandable by the microprocessor simulator and converts the internal state information into a form understandable by the display module.

18] A tool for visualizing events within a microprocessor comprising:
means receiving internal state information representative of events occurring in the microprocessor; and
means for graphically displaying an execution behavior of the instructions on the microprocessor based on the internal state information.

19] The tool for visualizing events within a microprocessor of claim 18, further comprising:
means for simulating operation of a microprocessor for a set of instructions; and
means for generating internal state information from the simulation.

20] The tool for visualizing events within a microprocessor of claim 18, further comprising:
means for exporting a set of instructions to a simulator in a understandable form;
means for importing results from the simulator; and
means for converting the results into internal state information representative of events occurring in the microprocessor.
